(19) United States
(12) Patent Application Publication
(10) Pub. No.: US 2026/0098497 A1
(43) Pub. Date: Apr. 9, 2026

(54) INJECTOR FOR DE-ICING DEVICE FOR AN AIR INTAKE OF AN AIRCRAFT TURBOJET NACELLE, AND ASSOCIATED METHOD

(71) Applicant: SAFRAN NACELLES, GONFREVILLE L'ORCHER (FR)

(72) Inventors: Alexis Yves-Marie LONCLE, MOISSY-CRAMAYEL (FR); Paul FERREY, MOISSY-CRAMAYEL (FR); Hazem KIOUA, MOISSY-CRAMAYEL (FR); François BELLET, MOISSY-CRAMAYEL (FR)

(21) Appl. No.: 19/114,587

(22) PCT Filed: Oct. 2, 2023
(86) PCT No.: PCT/EP2023/077226

§ 371 Date: Mar. 24, 2025

(30) Foreign Application Priority Data
Oct. 4, 2022 (FR) FR2210126

(51) Int. Cl. F02C 7/047; B64D 15/04; B64D 33/02

(52) U.S. Cl. CPC F02C 7/047; B64D 15/04; B64D 33/02; B64D 2033/0233

(57) ABSTRACT

An injector for a de-icing device for an air intake of an aircraft turbojet nacelle. The injector including a peripheral member internally defining a passage duct. The peripheral member including a peripheral mouth configured to inject a peripheral hot air flow so as to circulate a flow of fresh air in the passage duct from upstream to downstream. The peripheral member including an inner guide wall located downstream of the peripheral mouth. The peripheral member including a plurality of members for rotating the hot air flow during the injection thereof.

### TECHNICAL FIELD

The present invention relates to the field of aircraft turbojets and more particularly to an injector for a de-icing device for an air intake of an aircraft turbojet nacelle.

In a known way, an aircraft comprises one or more turbojets to allow it to be propelled by accelerating an air flow that circulates back and forth in the turbojet.

With reference to FIG. 1, there is shown a turbojet 100 extending along a turbojet axis X and comprising a fan 101 mounted so as to rotate about the turbojet axis X in a nacelle comprising an outer shell 102. Hereinafter, the terms “front” and “rear” are defined in relation to the circulation of the air flow F. At its front end, the turbojet 100 comprises an air intake 200 comprising a cavity 204 extending in an annular manner around the turbojet axis X, which comprises an inner wall 201 facing the turbojet axis X and an outer wall 202 which is opposite the inner wall 201, the walls 201, 202 are connected by a leading edge 203 also referred as the “air intake lip”. In this way, the air intake 200 allows to separate the incoming air flow F into an internal air flow FINT guided by the inner wall 201 and an external air flow FEXT guided by the outer wall 202. Hereafter, the terms inner and outer are defined radially with respect to the turbojet axis X.

As is well known, during the flight of an aircraft, as a result of the temperature and pressure conditions, ice is likely to accumulate near the leading edge 203 and the inner wall 201 of the air intake 200 and to form blocks of ice which are likely to be ingested by the turbojet 100. Such ingestions must be avoided in order to improve the service life of the turbojet 100 and reduce malfunctions.

To eliminate ice build-up, still referring to FIG. 1, it is known to circulate a hot air flow FAC in the inner cavity 204 in order to heat the inner wall 201 by thermal convection and thus avoid the build-up of ice which melts as it accumulates.

The hot air flow FAC is introduced into the inner cavity 204 by an injector 300 in the conventional form of a tube of cylindrical cross-section which is oriented in a direction perpendicular to the turbo-reactor axis X as shown in FIG. 2. The hot air flow FAC moves circumferentially in the inner cavity 204 so as to heat the inner wall 201.

In practice, the energy efficiency of such heating is low because the hot air flow FAC does not mix homogeneously with the fresh air flow already present in the inner cavity 204. This may lead to hot spots in the air intake 200, which may shorten its service life.

It has been proposed to use an injector comprising a peripheral member internally defining a passage duct. The peripheral member comprises a peripheral mouth configured to inject a peripheral hot air flow so as to circulate a fresh air flow in the passage duct. The performance of such an injector is high when the cross-section of the passage duct is large, to allow an optimum mixing between the fresh air flow and the hot air flow.

The installation of an injector with a large peripheral member is complex, as the injector must be removable via a mounting aperture for maintenance purposes. Also, the dimensions of the peripheral member must be reduced to allow the removal via the mounting aperture, the dimensions of which are determined.

### PRESENTATION OF THE INVENTION

The invention relates to an injector for a de-icing device for an air intake of an aircraft turbojet nacelle, the injector comprising a peripheral member internally defining a passage duct, the peripheral member comprising a peripheral mouth configured to inject a peripheral hot air flow so as to cause a fresh air flow to circulate in the passage duct from upstream to downstream, the peripheral member comprising an inner guide wall located downstream of the peripheral mouth, the peripheral member comprising a plurality of members for rotating the hot air flow during the injection thereof.

The peripheral member is circumferential and comprises a circumferential mouth configured to inject a circumferential hot air flow. The mouth has a closed contour.

Thanks to the invention, the fresh air flow and the hot air flow circulate concentrically, which allows the fresh air flow to be accelerated by the hot air flow while at the same time favoring their mixing. The inner guide wall helps to create a negative pressure area upstream of the passage duct in order to accelerate the fresh air flow from upstream to downstream while guiding the hot air flow pressed against the inner guide wall.

The use of rotating members also promotes mixing by forming turbulence at the interface between the hot air flow and the fresh air flow. Advantageously, such an injector remains effective even for a peripheral member with a small diameter, preferably less than half the distance defined between the partition and the leading edge of the air intake, i.e. its front end. Preferably, the diameter of the peripheral member is less than 150 mm.

Advantageously, the inner cavity of the air intake is heated with a mixed air flow of optimum temperature, limiting the appearance of hot spots, with a high flow rate so as to allow an optimum calorie transfer with the walls. This improves de-icing performance while reducing overall dimension.

In a preferred aspect, the injector comprises a supply member, connected to the peripheral member, comprising a mounting foot configured to be attached to the air intake in order to be supplied by the hot air flow. Such an injector is adapted to be mounted by its mounting foot to a through aperture in a partition of a conventional air intake.

Preferably, since the supply member extends along a mounting axis and the mounting foot comprises a passage cross-section, the peripheral member has an overall cross-section, defined in projection in a plane orthogonal to the mounting axis, which is smaller than that of the passage cross-section of the mounting foot. Advantageously, if the mounting foot may be moved via a through aperture in a partition of a conventional air intake, the peripheral member may also be moved in a similar way. In other words, it allows the injector to be removed via the through aperture for maintenance purposes, which is advantageous. Thanks to the rotating members, a peripheral member of reduced dimensions may be used to achieve optimal mixing while still being able to undergo a traditional maintenance step.

Preferably, the peripheral member comprises an inner guide wall, the inner guide wall being located downstream of the peripheral mouth.

In one aspect, the peripheral member comprising an inner guide wall, a plurality of rotating members is positioned on the inner guide wall. The use of rotating members on the inner guide wall allows the hot air flow to be twisted following its injection while taking advantage of the fact that the hot air flow is pressed against the inner guide wall. Positioning the rotating members on the inner guide wall means that large rotating members may be used to achieve high levels of rotation. Advantageously, the use of rotating members on the inner guide wall allows the fresh air flow circulating in the passage duct to be twisted, which also improves mixing.

Preferably, the length of the rotating members is at least 90% of the length of the inner guide wall, which improves the rotation. Preferably, the cross-section of a rotating member, defined transversely to the injection axis, increases from downstream to upstream so as to allow the hot air flow to rotate progressively while having a moderate impact on the fresh air flow.

According to another aspect, a plurality of rotating members are positioned in the peripheral mouth. In this way, the rotating members are integrated into the mouth, ensuring an optimum pressing against the inner guide wall. Preferably, the rotating members have a length of between 2 and 20 times the thickness of the peripheral mouth 31. Preferably, the rotating members are less than 20 mm long.

Preferably, the peripheral member comprising an inner guide wall, the inner guide wall is smooth.

Preferably, the peripheral member is configured to accelerate the fresh air flow by the Coanda effect in the passage duct. The hot air flow matches the outer surface of the peripheral body to create a negative pressure upstream of the passage duct so as to accelerate the fresh air flow from upstream to downstream. In this way, without a rotating member, the air flow rate into the cavity is accelerated. This improves the mixing of hot and fresh air flows and promotes the circulation of air flows in the circumferential direction of the cavity.

Preferably, the peripheral member has a peripheral mouth oriented downstream. Such a peripheral mouth advantageously allows the hot air flow to follow the outer surface of the peripheral body to accelerate the fresh air flow. The pressing is optimal.

Preferably, the inner guide wall comprises a downstream end extending parallel to the injection axis so as to straighten the hot air flow. The hot air flow allows to guide the fresh air flow and mixes with the latter in the direction of injection.

Preferably, the inner guide wall is flared radially downstream.

Preferably, the inner guide wall allows to promote the creation of a vacuum area upstream of the flow duct so as to accelerate the fresh air flow from upstream to downstream while guiding the hot air flow pressed against the inner guide wall.

Preferably, the peripheral member comprises a heating cavity supplied with a hot air flow, the heating cavity comprising an injection channel located directly close to the peripheral mouth, the injection channel is convergent so as to accelerate the hot air flow towards the peripheral mouth. The convergent channel allows to minimize the pressure losses in the hot air flow. The high velocity of the hot air flow at the injection outlet allows to increase the flow rate of the fresh air flow by the entrainment effect.

Preferably, the peripheral member comprises a peripheral lip extending into the heating cavity and partly delimiting the injection channel. This allows the injection speed to be conveniently adjusted to achieve the desired pressing effect.

Preferably, the peripheral lip extends in the continuity of the inner guide wall. This allows to form a peripheral member in a practical way without assembly. Preferably, the walls of the peripheral member are made of the same material.

According to one aspect of the invention, the inner guide wall is inclined with respect to the injection axis by an angle of inclination of between 5° and 45°, preferably between 10° and 15°, even more preferably equal to 12°. This angle of inclination allows to provide an optimum Coanda effect for an efficient acceleration and mixing.

In one aspect, each rotating member comprises an upstream portion and a downstream portion which are offset in the circumferential direction so as to set in rotation the hot air flow.

The invention also relates to a de-icing device for an air intake of an aircraft turbojet nacelle extending along a turbojet axis, the air intake comprising an inner cavity extending in an annular manner around the turbojet axis and which comprises an inner wall facing the turbojet axis and an outer wall which is opposite the inner wall, the walls being connected by a leading edge, the de-icing device comprising at least one injector as previously presented for a hot air flow into the inner cavity along an injection axis oriented from upstream to downstream.

The invention also relates to an air intake of an aircraft turbojet nacelle extending along an axis, the air intake comprising an inner cavity, extending in an annular manner around the axis, which comprises an inner wall facing the axis and an outer wall which is opposite the inner wall, the walls being connected by a leading edge, the air intake comprising a de-icing device as previously presented.

The invention also relates to a method for using a de-icing device as previously presented for de-icing an air intake of an aircraft turbojet nacelle extending along an axis, the air intake comprising an inner cavity, extending in an annular manner about the axis, which comprises an inner wall facing the axis and an outer wall which is opposite the inner wall, the walls being connected by a leading edge.

The method comprises a step of injecting a peripheral, twisted hot air flow so as to cause a fresh air flow to circulate in the passage duct, the fresh air flow circulating from upstream to downstream with respect to an injection axis, the fresh air flow circulating inside the hot air flow of peripheral shape so as to allow mixing between the hot air flow and the fresh air flow.

### PRESENTATION OF FIGURES

The invention will be better understood on reading the following description, which is given solely by way of example, with reference to the annexed drawings, which are given by way of non-limiting examples, wherein identical references are given to similar objects and wherein:

FIG. 1 is a schematic representation of an air intake of a nacelle according to the prior art.

FIG. 2 is a schematic cross-sectional representation of the circulation of a hot air flow in the air intake according to the prior art.

FIG. 3 is a schematic representation of an air intake of a nacelle according to the invention.

FIG. 4 is a schematic representation from the downstream end of an injector according to one embodiment of the invention.

FIG. 5 shows a schematic cross-section of the injector.

FIG. 6 shows a schematic representation in angular section of the peripheral member of the injector.

FIG. 7 is a schematic representation of an injector in a first embodiment.

FIG. 8 is a cross-sectional view of an injector in the first embodiment.

FIG. 9 is another schematic representation of an injector according to the first embodiment.

FIG. 10 is a partial schematic representation of an injector according to a second embodiment.

FIG. 11 is a close-up representation of an injector according to the second embodiment.

FIG. 12 is a schematic cross-section of the peripheral member of the injector with the circulation of the hot air flow through the peripheral member and its rotating.

FIG. 13 is a schematic cross-sectional representation of the circulation of a hot air flow in the air intake according to the invention.

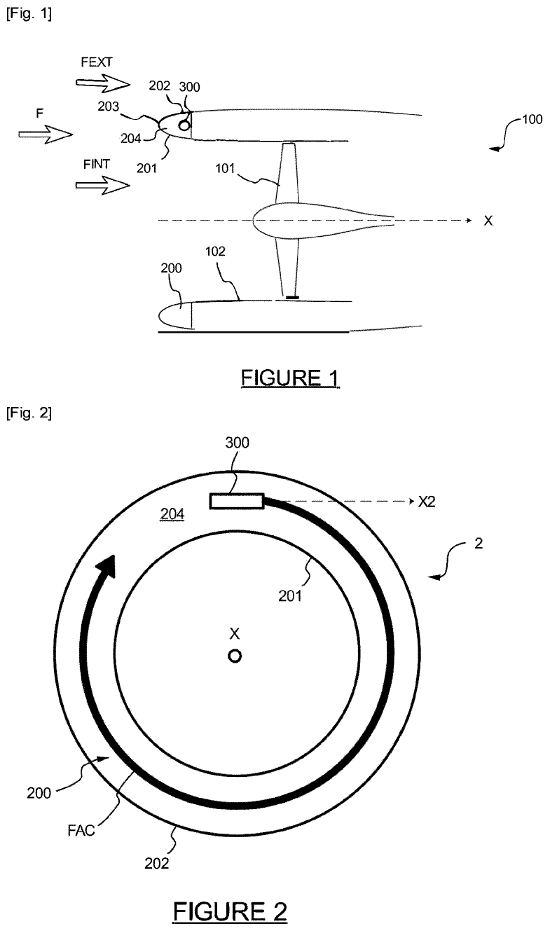

It should be noted that the figures set out the invention in detail in order to implement the invention, said figures of course being able to be used to better define the invention if necessary.

### DETAILED DESCRIPTION OF THE INVENTION

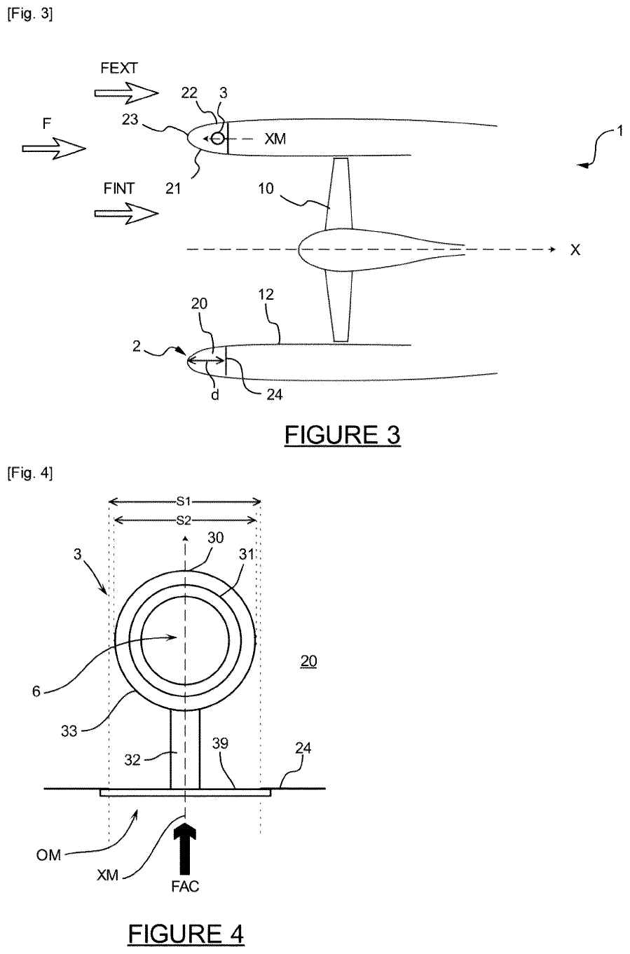

With reference to FIG. 3, there is shown a turbojet 1 extending along a turbojet axis X and comprising a fan 10 mounted so as to rotate about the turbojet axis X in a nacelle comprising an outer shell 12. In the following, the terms “front” and “rear” are defined in relation to the air flow F. At its front end, the turbojet 1 comprises an air intake 2 which comprises an inner cavity 20, extending in an annular manner around the turbojet axis X, which comprises an inner wall 21 facing the turbojet axis X and an outer wall 22 which is opposite the inner wall 21. The walls 21 and 22 are connected by a leading edge 23, also referred as the “air intake lip”. In this way, the air intake 2 allows to separate the incoming air flow F into an inner air flow FINT guided by the inner wall 21 and an external air flow FEXT guided by the outer wall 22. Hereafter, the terms inner and outer are defined radially with respect to the turbojet axis X. The inner cavity 20 is delimited at the front by the inner wall 21 and the outer wall 22 connected by the leading edge 23. In this example, the inner cavity 20 is delimited at the rear by a partition wall 24.

The inner cavity 20 is filled with a fresh air flow FAF, for example, a stagnant air flow or a hot air flow that has been injected previously and has cooled.

The turbojet 1 comprises a de-icing device to eliminate ice build-up on the air intake 2. In a known way, the de-icing device comprises an injector 3 for a hot air flow FAC into the inner cavity 20. The circulation of a hot air flow FAC allows by thermal convection to prevent the build-up of ice, which melts as it accumulates. Preferably, the hot air flow FAC is taken from the turbojet 1.

As illustrated in FIG. 4, the injector 3 comprises a peripheral member 30 internally defining a passage duct 6. The passage duct 6 is through. In this example, the peripheral member 30 has a circular shape, but it goes without saying that it could have any other peripheral shape, for example an elongated shape, in particular an oblong shape. With reference to FIG. 4, the passage duct 6 has a disc-shaped cross-section, but other shapes may of course be suitable.

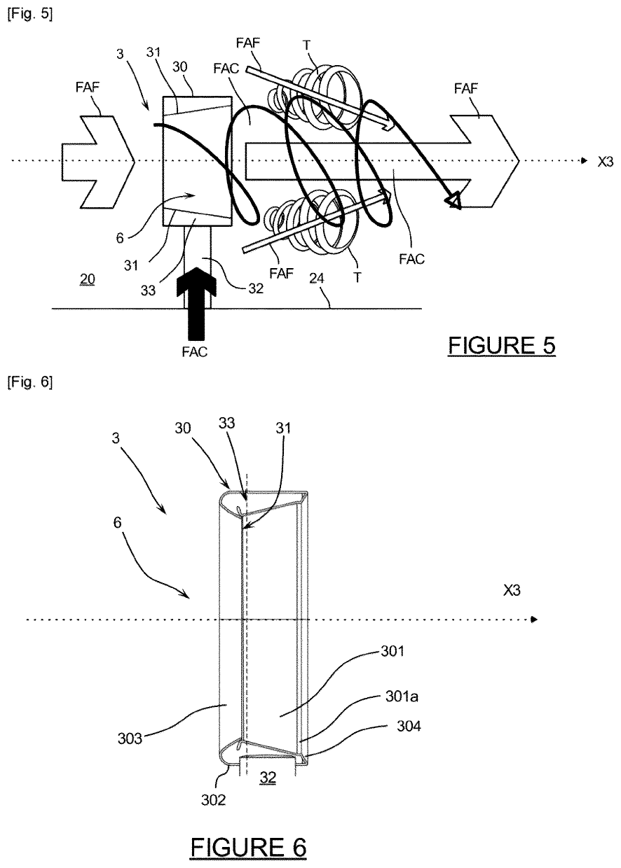

As illustrated in FIG. 5, the peripheral member 30 is oriented along an injection axis X3 along which the passage duct 6 extends. The injection axis X3 is oriented from upstream to downstream in FIG. 5. In this example, with reference to FIG. 13, the injection axis X3 extends substantially tangentially/perpendicularly with respect to the turbojet axis X.

As illustrated in FIGS. 4 and 6, the peripheral member 30 comprises a peripheral mouth 31 configured to inject a hot air flow FAC from upstream to downstream along the injection axis X3. The peripheral mouth 31 has a similar shape to the peripheral member 30. In this example, the peripheral mouth 31 is circular in shape and faces downstream.

With reference to FIG. 4, the peripheral member 30 comprises a heating cavity 33 and a supply member 32 configured to supply the heating cavity 33 with a hot air flow FAC. The supply member 32 is preferably in the form of a hollow shroud. In this example, the supply member 32 comprises a mounting foot 39 configured to be attached to the air intake 2, in particular, to the partition wall 24. As illustrated in FIG. 4, the supply member 32 extends along a mounting axis XM which is preferably substantially parallel to the turbojet axis X (see FIG. 3) but this could of course be different. The heating cavity 33 defines a radially inner wall and a radially outer wall. The passage duct 66 extends inside the radially inner wall.

As illustrated in FIG. 4, the mounting foot 39 defines a passage cross-section S1 with respect to said mounting axis XM. In this example, the mounting foot 39 has the shape of a disc and the passage cross-section corresponds to the surface of said disc. It goes without saying that the shape of the mounting foot 39 could be different. In practice, the mounting foot 39 is mounted in a through aperture OM formed in the partition wall 24, the cross-section of which is substantially similar to that of the mounting foot 39. During a maintenance operation, the injector 3 is moved along the mounting axis XM through the through aperture OM.

The peripheral member 30 has, projected in a plane orthogonal to the mounting axis XM, an overall cross-section S2 which is smaller than the passage cross-section S1 so that the injector 3 may be removed via the aperture OM. This dimensional constraint requires the injector 3 to allow an optimum mixing of the hot air flow FAC with the fresh air flow FAF.

With reference to FIG. 5, the peripheral mouth 31 is configured to inject, from the heating cavity 33, a hot air flow FAC of peripheral shape so as to circulate a fresh air flow FAF in the passage duct 6. The fresh air flow FAF circulates from upstream to downstream with respect to the injection axis X3, the fresh air flow FAF circulating inside the hot air flow FAC of peripheral shape so as to allow mixing between the hot air flow FAC and the fresh air flow FAF. As will be shown later, the hot air flow FAC has a twisting motion when injected, while at the same time having a peripheral shape.

As shown in FIG. 5, the hot air flow FAC has a peripheral shape, in this case an annular cross-section, and the fresh air flow FAF is guided axially along the injection axis X3 inside the hot air flow FAC. In other words, the hot air flow FAC and the fresh air flow FAF are concentric. As will be shown below, the peripheral member 30 is configured to accelerate the fresh air flow FAF by the Coanda effect in the passage duct 6 as shown in FIG. 5.

With reference to FIG. 5, the hot air flow FAC is guided by the surface of the peripheral member 30 so as to allow high-speed injection. This generates, downstream of the peripheral mouth 31, a negative pressure area which allows the fresh air flow FAF located upstream of the peripheral mouth 31 to be sucked in. In other words, as a result of the injection of the hot air flow FAC, the fresh air flow FAF is drawn downstream along the injection axis X3, which increases its speed in the manner of a blade-less fan.

Advantageously, with reference to FIG. 5, the negative pressure generated downstream also allows to suck in fresh air flows FAF that have bypassed the passage duct 6, which generates turbulences T downstream of the peripheral member 30. Such turbulences T is advantageous as it encourages mixing between the hot air flow FAC and the fresh air flow FAF, thus preventing the appearance of hot spots in the inner cavity 20.

With reference to FIG. 6, the peripheral member 30 is shown in general manner in longitudinal cross-section along the injection axis X3. The peripheral member 30 comprises a cross-section comprising an inner guide wall 301, an outer wall 302, an upstream wall 303 and a downstream wall 304. These walls define the interior of the heating cavity 33. Preferably, the walls 301-304 of the peripheral member 30 are made of the same material.

With reference to FIG. 6, the upstream wall 303 is preferably convex and ducted so as to allow a turbulence-free circulation of the fresh air flow FAF. The upstream wall 303 is used to guide fresh air flows FAF into the passage duct 6 so that they are accelerated and fresh air flows FAF outside the peripheral member 30 to generate turbulences T downstream. The outer wall 302 is cylindrical so as to axially guide the fresh air flow FAF which bypasses the passage duct 6.

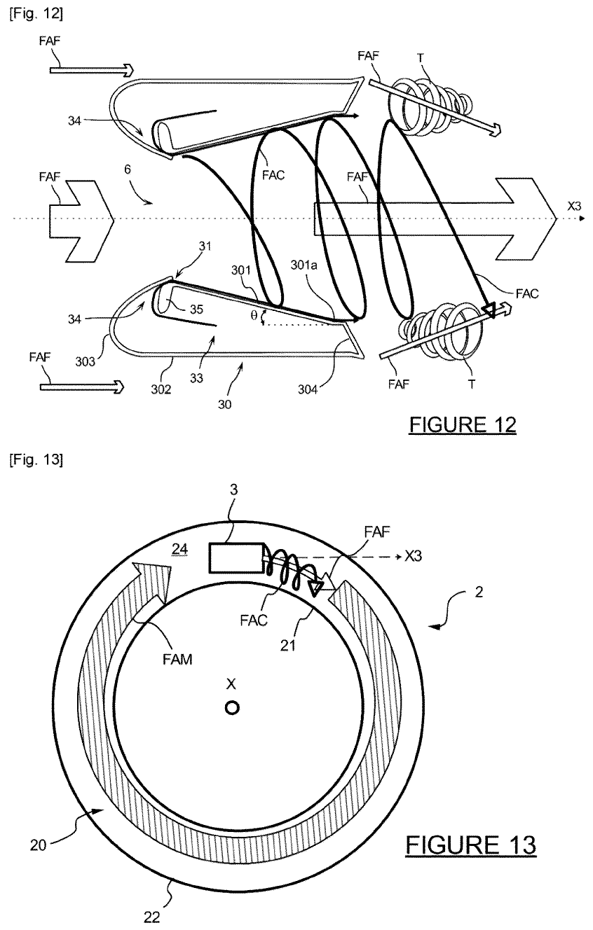

In this example, the inner guide wall 301 diverges from upstream to downstream, i.e. flares radially from upstream to downstream. In other words, passage duct 6 has an increasing cross-section. The inner guide wall 301 is located downstream of the peripheral mouth 31 so as to guide the hot air flow FAC out of the peripheral mouth 31 in order to obtain the Coanda effect. As will be shown later, the hot air flow FAC circulates in contact with the inner guide wall 301, which allows the fresh air flow FAF to be sucked to accelerate it. With reference to FIG. 12, the inner guide wall 301 is inclined relative to the injection axis X3 by an angle of inclination 0 of between 5° and 45° in order to obtain an optimum Coanda effect. Preferably, the angle of inclination 0 is between 10° and 15°, preferably 12°. Advantageously, the peripheral mouth 31 is oriented so as to allow injection along the inner guide wall 301. The hot air flow FAC is thus pressed against the inner guide wall 31.

In this example, the inner guide wall 301 comprises a downstream end 301a extending along the injection axis X3. The downstream end 301a allows the hot air flow FAC to be straightened so that the fresh air flow FAF may be guided along the injection axis X3.

With reference to FIG. 12, the downstream wall 304 is configured to amplify the turbulences T and has, in this example, an unducted truncated shape. In order to allow an injection at very high speed via the peripheral mouth 31, the heating cavity 33 comprises an injection channel 34 located directly next to the peripheral mouth 31. Preferably, the injection channel 34 is convergent so as to accelerate the hot air flow FAC as it is injected through the peripheral mouth 31. Preferably, as illustrated in FIG. 12, the peripheral member 30 comprises a peripheral lip 35 extending into the heating cavity 33 and partly delimiting the injection channel 34. Such a peripheral lip 35 allows to precisely define the shape of the injection channel 34 and, consequently, the desired compression. Preferably, the peripheral lip 35 extends continuously with the inner guide wall 301 so as to define the peripheral mouth 31 between the inner guide wall 301 and the upstream wall 303 of the peripheral member 30.

According to the invention, the peripheral member 30 comprises a plurality of rotating members for rotating the hot air flow FAC as it is injected into the inner cavity 20 of the air intake 2. As will be explained in more detail later, these rotating members allow to generate a twist on the hot air flow FAC while keeping it pressed against the inner guide wall 301 to allow an optimum suction of the fresh air flow FAF. This type of twist allows to improve the mixing of the hot air flow FAC with the fresh air flow FAF, while keeping the injector 3 small.

Preferably, the angle of inclination of the rotating members with respect to the injection axis is between 20° and 40° to obtain the desired twisting effect. Preferably, as illustrated in FIG. 8, each rotating member 4 comprises an upstream portion 4A and a downstream portion 4B which are offset in the circumferential direction so as to rotate the hot air flow FAC. Preferably, the ratio between the length of a rotating member and the distance between two rotating members is between 1 and 1.4 to ensure a compromise between the number of rotating members and the deflection capacity.

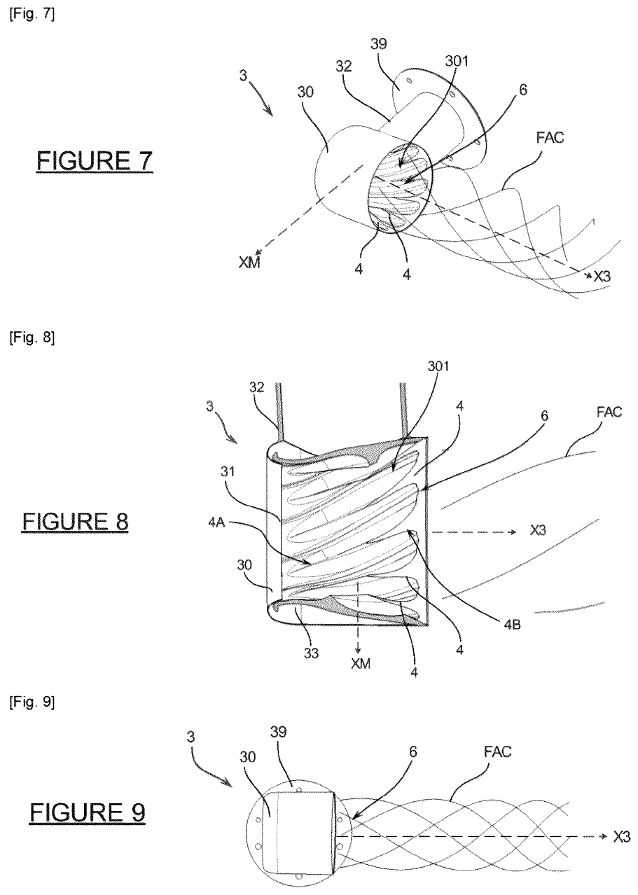

In a first embodiment, with reference to FIGS. 7 to 9, a plurality of rotating members 4 are positioned on the inner guide wall 301. Each rotating member 4 projects towards the injection axis X3 so as to form a relief on the inner guide wall 301. Preferably, a rotating member 4 is in the form of a bulge formed between two recesses.

Preferably, the number, shape and length of the rotating members 4 are adapted so as to obtain the desired twisting effect. Preferably, the length of the rotating members 4 is at least 90% of the length of the inner guide wall 301. Preferably, the cross-section of a rotating member 4, defined transversely to the injection axis X3, increases from downstream to upstream so as to allow the hot air flow FAC and also the fresh air flow FAF to rotate progressively via the rotating members 4.

Preferably, the rotating members 4 are distributed uniformly around the periphery of the inner guide wall 301 so as to obtain a uniform twisting effect. In this example, the rotating members 4 are made from the material of the inner guide wall 301.

Thus, when a hot air flow FAC is injected via the mouth 31, the hot air flow FAC is pressed against the inner guide wall 301, which drives it in rotation at high speed. This allows to create a suction of the fresh air flow FAF and generates turbulence due to the rotation, which improves mixing between the hot air flow FAC and the fresh air flow FAF.

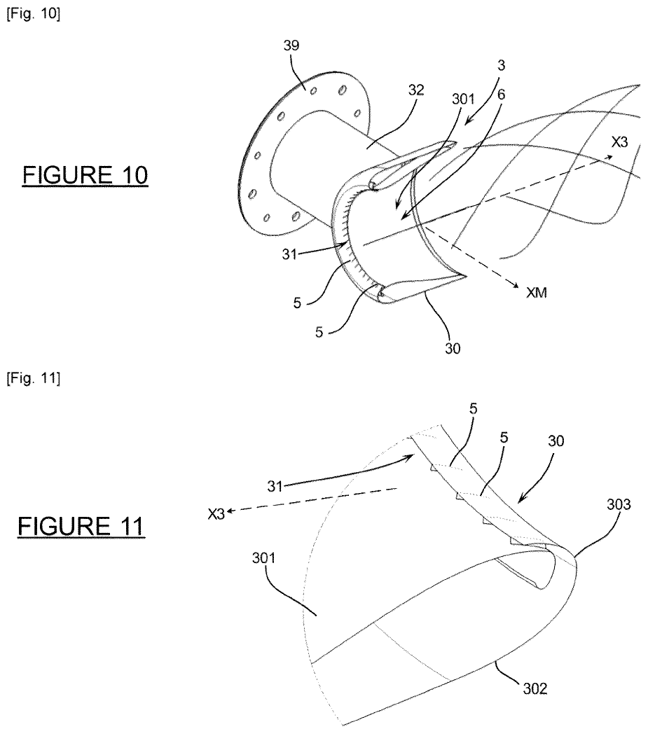

In a second embodiment, with reference to FIGS. 10 to 11, a plurality of rotating members 5 are positioned in the peripheral mouth 31. Preferably, the number, shape and length of the rotating members 5 is adapted so as to obtain the desired twisting effect. Preferably, the length of the rotating members 5 is between 2 and 20 times the thickness of the peripheral mouth 31 so as to allow a rotation while maintaining a small overall dimension in the peripheral mouth 31. Preferably, the rotating members 5 are less than 20 mm long.

Preferably, the rotating members 5 are distributed uniformly around the periphery of the mouth 31 so as to obtain a homogeneous twisting effect. In this example, the rotating members 5 are made from the material of the peripheral member 30. Preferably, the inner guide wall 301 remains smooth so as not to interfere with the suction of the fresh air flow FAF. Preferably, each rotating member 5 is in the form of a fin.

Thus, when a hot air flow FAC is injected via the mouth 31, the hot air flow FAC is twisted and then pressed against the inner guide wall 301. This allows to create a suction of the fresh air flow FAF and generates turbulence due to the rotation, which improves mixing between the hot air flow FAC and the fresh air flow FAF. In this embodiment, the fresh air flow FAF is not set into rotation by the rotating members 5.

It goes without saying that the different embodiments are compatible and that an injector 3 could comprise rotating members in the peripheral mouth 31 and on the inner guide wall 301.

In the two embodiments described above, the peripheral member 30 has, projected in a plane orthogonal to the mounting axis XM, an overall cross-section S2 which is smaller than that of the passage cross-section S1 of the mounting foot 39 as illustrated in FIG. 4. Maintenance may be carried out in a practical way. Preferably, the passage cross-section S1, defining a maintenance passage, has a diameter of between 40 mm and 150 mm so that it may be adapted to an existing de-icing device. Preferably, the peripheral member 30 has a diameter of between 35 mm and 140 mm. Preferably, a clearance is defined between the diameter of the passage cross-section S1 and the diameter of the overall cross-section S2, which is between 5 mm and 10 mm.

Preferably, the peripheral member 30 has a small diameter, preferably less than half the distance d (FIG. 3) defined between the partition 24 and the leading edge of the air intake 2, i.e. its front end. Preferably, the diameter of the peripheral member 30 is less than 140 mm.

An example of implementation of a method for using a de-icing device according to the invention will now be presented. The method comprises a step consisting of injecting a hot air flow FAC of peripheral shape into the inner cavity 20 so as to circulate a fresh air flow FAF in the passage duct 6. The fresh air flow FAF circulates from upstream to downstream with respect to the injection axis X3 inside the hot air flow FAC, which is peripheral and twisted as shown in FIGS. 12 and 13.

When injected, the hot air flow FAC is set in rotation by the rotating members 4, 5 of the peripheral member 30, which increases turbulence and improves mixing with the fresh air flow FAF while maintaining a limited overall dimension.

The hot air flow FAC is injected at very high speed due to its optimal compression by the injection channel 34 into the heating cavity 33. When injected, the hot air flow FAC matches the inner guide wall 301, creating a negative pressure in the passage duct 6, which sucks in the upstream fresh air flow FAF. As a result, the fresh air flow FAF is accelerated when the hot air flow FAC is injected, which increases the air flow rate in the inner cavity 20 of the air intake 2. The thermal exchanges with the walls 21, 22, 23 of the air intake 2 is encouraged, which prevents any build-up of ice.

As shown in FIG. 13, when the fresh air flow FAF circulates inside the hot air flow FAC, which is peripheral and twisted, the latter mix at the outlet of the injector 3 so as to form a mixed air flow FAM of optimum temperature. In other words, the risk of a hot spot forming in air intake 2 is reduced. The service life of air intake 2 is increased. Such an injector 3 may be mounted in an existing air intake 2 via a through aperture OM formed in the internal partition 24 of the air intake 2.

In addition, due to the characteristics of the peripheral member 30, turbulence T appears downstream of the peripheral member 30, which allows to homogenize the mixture between the fresh air flow FAF and the hot air flow FAC. The mixed air flow FAM thus ensures a homogeneous heating of the walls 21, 22, 23 of the air intake 2.

Thanks to the invention, a mixed air flow FAM of optimum temperature and high flow rate circulates in the inner cavity 20 to de-ice the walls 21, 22, 23 of the air intake 2.

1. An injector for a de-icing device for an air intake of an aircraft turbojet nacelle, the injector comprising:
a peripheral member internally defining a passage duct, the peripheral member comprising
a peripheral mouth configured to inject a peripheral hot air flow so as to cause a fresh air flow to circulate in the passage duct from upstream to downstream,
an inner guide wall located downstream of the peripheral mouth, and
a plurality of members for rotating the hot air flow during the injection thereof.

2. The injector according to claim 1, wherein the injector comprises a supply member, connected to the peripheral member, comprising a mounting foot configured to be attached to the air intake in order to be supplied by the hot air flow.

3. The injector according to claim 2, wherein, the supply member extends along a mounting axis, the mounting foot defining a passage cross-section, the peripheral member defines an overall cross-section, defined in projection in a plane orthogonal to the mounting axis, which is less than that of the passage cross-section of the mounting foot.

4. The injector according to claim 1, wherein the peripheral member further comprises an inner guide wall, and wherein the inner guide wall is located downstream of the peripheral mouth.

5. The injector according to claim 4, wherein the inner guide wall is flared radially downstream, and wherein a plurality of rotating members are positioned on the inner guide wall.

6. The injector according to claim 4, wherein the inner guide wall is smooth.

7. The injector according to claim 1, wherein a plurality of rotating members are positioned in the peripheral mouth.

8. The injector according to claim 1, wherein each rotating member comprises an upstream portion and a downstream portion which are offset in circumferential direction so as to set in rotation the hot air flow.

9. A de-icing device for the air intake of the aircraft turbojet nacelle extending along a turbojet axis, the air intake comprising an inner cavity extending in an annular manner around the turbojet axis and which comprises an inner wall facing the turbojet axis and an outer wall which is opposite the inner wall, the inner wall and the outer wall being connected by a leading edge, the de-icing device comprising:
at least one of the injectors according to claim 1 of the hot air flow into the inner cavity along an injection axis oriented from upstream to downstream.

10. An air intake of the aircraft turbojet nacelle extending along the turbojet axis, the air intake comprising:
the de-icing device according to claim 9.

11. A method for using the de-icing device according to claim 9 for de-icing the air intake of the aircraft turbojet nacelle extending along the turbojet axis, the method comprising:
injecting the peripheral and twisted hot air flow so as to cause the fresh air flow to circulate in the passage duct, the fresh air flow circulating from the upstream to the downstream with respect to the injection axis, the fresh air flow circulating inside the hot air flow of peripheral shape so as to allow mixing between the hot air flow and the fresh air flow.
